(19) United States
(12) Patent Application Publication
(10) Pub. No.: US 2015/0347909 A1
(43) Pub. Date: Dec. 3, 2015

(54) MULTI-OBJECTIVE AND CONSTRAINED AGENT WALK

(71) Applicant: Axon AI, LLC, Harrisonburg, VA (US)

(72) Inventor: Sven A. Brueckner, Harrisonburg, VA (US)

(21) Appl. No.: 14/728,724

(22) Filed: Jun. 2, 2015

Related U.S. Application Data
(60) Provisional application No. 62/007,165, filed on Jun. 3, 2014.

(51) Int. Cl. G06N 5/04; G06N 7/00

(52) U.S. Cl. CPC G06N 5/04; G06N 7/005

(57) ABSTRACT

Individual autonomous computational processes (“agents”) representing application-specific data items (e.g., representations of real-world entities or events, any-media documents, models, etc.) are provided with an application-independent method and data structures to combine arbitrary objectives and constraints into a goal-oriented sequence of movement steps in a global topology based on virtual or physical sensor information. The invention specifies a cyclical two-step agent movement process where the first step determines the proposed movement step relative to the agent's current position and the second step attempts to attain the new position implied by the movement step. The first step in the process first combines movement proposals from each of the objectives defined by the application and then enforces any of the application-defined constraints. The invention includes a number of prescriptions on how standard agent movement objectives are to be realized in this agent process.

### REFERENCE TO RELATED APPLICATION

This application claims priority from U.S. Provisional Patent Application Ser. No. 62/007,165, filed Jun. 3, 2014, the entire content of which is incorporated herein by reference.

### FIELD OF THE INVENTION

This invention relates generally to information processing and, in particular, to a method of combining multiple objectives and constraints into the ongoing stepwise movement decision of autonomous agents representing real-world entities or data items according to real-world geography or computational topology representations within a distributed computing environment.

### BACKGROUND OF THE INVENTION

Many computational applications place autonomous computational processes (“agents”) into a topology (e.g., metric space, graph) and have them move in this topology over time to accomplish application-specific reasoning or decision tasks. In some cases (e.g., control of real-world vehicles as in [1][2], or geospatial reasoning as in [3][4]), the topology is a reflection of a real-world geography (2D plane or 3D volume). In other cases, the topology is an abstraction (e.g., clustering [5] or layout [6] volumes, task hierarchy graphs [7]) within which entities perform collective reasoning. The movement of these agents in their respective topology needs to combine (potentially competing) objectives pursued by the agent (e.g., reach a destination while minimizing exposure) as well as account for any constraints that apply to the specific agent (e.g., maximum possible speed or turning radius).

### SUMMARY OF THE INVENTION

This invention is directed to the control of the stepwise movement of an autonomous computational process (“agent”) embedded in an arbitrary topology where the resulting trajectory of the agent movement combines an arbitrary number of application-specific objectives and constraints. With each step, the agent's movement decision process combines contributions from each objective into a preliminary step proposal and then applies any constraints to that preliminary step proposal to arrive at the final step proposal. Depending on the specific realization of the agent, that final step proposal may be directly applied to the current agent location in the topology, or transmitted as a relocation request to the agent's movement apparatus.

The agents embodying this invention are data structures in computational processes executed by one or many processors on a single or a collection of hardware platforms, where each such data structure references a location in a metric space. Any memory maintained by the agents as part of this invention is presumed to be computer memory (e.g., Random Access Memory (RAM), processor cache, (temporary) files stored on internal or external hard disks, databases). The location of any real-world entity represented by any agent may but does not need to correspond to the physical arrangement of the hardware platforms that execute the agents' repeated decision process.

### BRIEF DESCRIPTION OF THE DRAWINGS

FIG. 1 illustrates agents embedded in (having a location in) a metric space;

FIG. 2 shows how the movement decision framework combines multiple objectives and constraints;

FIG. 3 portrays multiple phases of a Levy Walk generated by the corresponding objective;

FIG. 4 shows the steps of the Levy Walk step calculation;

FIG. 5 illustrates the object response objective's step calculation in the example of 3 objects;

FIG. 6 exemplifies the gridding of a metric space where each grid cell carries three scalar values (shown as shaded cylinders) forming three fields over the topology;

FIG. 7 depicts the translation of fields into sets of field-strength “objects” in preparation of the “Response to Objects” objective step vector calculation; and

FIG. 8 demonstrates the application of an exclusion zone as a movement constraint.

### DETAILED DESCRIPTION OF THE INVENTION

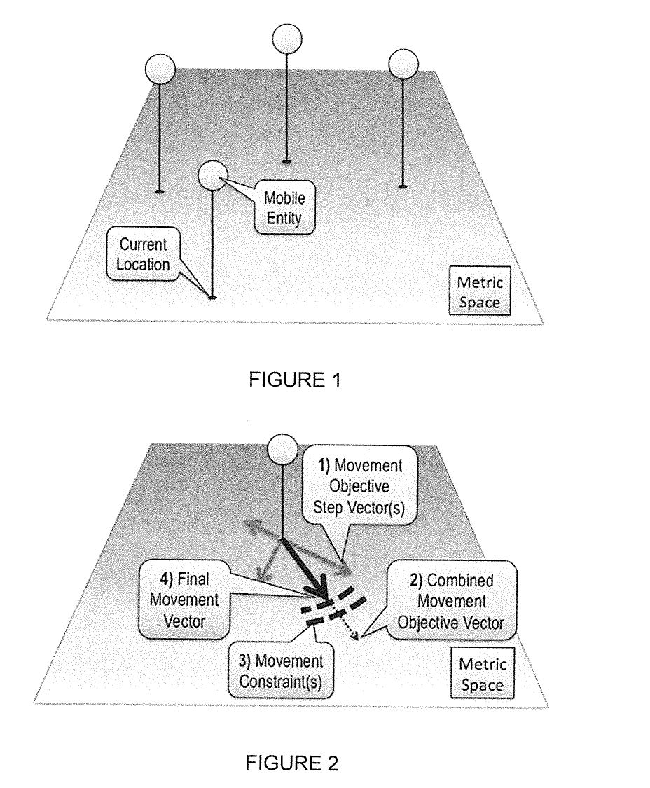

This invention defines a general stepwise movement decision and actuation component of an autonomous computational process (“agent”) embedded in an arbitrary topology where the resulting trajectory of the agent movement combines an arbitrary number of application-specific objectives and constraints. Without loss of generality, FIG. 1 illustrates the embedding of such agents in a metric space topology, but graph embedding where agent locations are specific graph nodes or other topologies are included in this invention too.

Once embedded in the topology, the agents may move in it (change their location) to accomplish their individual or joined application task. In autonomous agent models, the movement is computed by the agent itself. Other models decide the spatial movement on behalf of an agent. But in either case, the decision process effectively results in a movement step proposal that, applied to the agent's location, implies a new location the agent is supposed to attain. Depending on the specific application, the attainment of the new location may be instantaneous and precise (i.e., the agent is assigned the new location), or delayed and approximated as in the case of vehicles that treat the new location as a waypoint and use human or autonomous control to approach it within the physical constraints of the environment.

Thus, an iterative agent movement process has the following two steps that are repeated over time either at fixed intervals or triggered by events (e.g., new location reached):
Step 1. Compute movement step proposal from current agent location
Step 2. Actuate the movement of the agent toward the new location implied by the movement step proposal.

The present invention defines a generic decision framework for the computation of the movement step proposal (Step 1).

### Multi-Objective & Constrained Movement Decision

The movement decision for a given agent at its current location often has to satisfy multiple objectives and constraints. Here we put forth a movement decision framework that combines an arbitrary number of objectives and adheres to one or more constraints.

Our movement decision framework defines the following steps that result in the movement step proposal for the agent. FIG. 2 illustrates these steps in the case of a metric space embedding.
1) For each movement objective in arbitrary order, compute a movement objective step contribution from the current location of the entity
2) The preliminary movement step proposal is the topology-specific combination of these step contributions
3) For each movement constraint in a given order, assess the preliminary movement step proposal and its implied agent destination and, as required by the constraint, modify the step proposal accordingly. After all constraints are applied, the final movement step proposal results.

### Movement Objective Contributions and Constraints in a Metric Space

If the application agent is embedded in a metric space, the movement objective step contributions, the preliminary movement step proposal, and the final movement step proposal all take the form of vectors in that space. The combination of objective step contributions is a vector sum, and the application of constraints may change the length but not the direction of the step proposal vector. In the following, we specify generic strategies for the computation of step vectors for typical classes of objectives and strategies for constraint application. These strategies form a library that application-developers may draw on.

### Objective: Random Noise

Artificial random noise is often added to movement decisions to avoid entrapment of the entity in local optima in the decision landscape, especially when multiple agents seek to accomplish a joint set of objectives and the application is not linked to a physical environment that could serve as the source for real-world noise. A typical example of an application that requires artificial noise is iterative force-directed layout of graphs (e.g., for visualization).

To add random noise into the movement decision process, we compute an objective step contribution as follows:
1) We create a step vector of unit length and with a direction in the [0, 2π] interval using a random number generator for the desired probability distribution. For instance, to add White Noise, we would use a uniform random distribution with equal probability in [0, 27π].
2) Optionally, we scale the length of the step vector by multiplying it with an application parameter w.

### Objective: Levy Dispersion

In several application domains, for instance in swarming robotics, a rapid dispersion of one or more agents in the metric space is a desirable objective. Research [7] has shown that the Levy Walk model, due to its “fat tail” distribution, exhibits dispersion characteristics superior to other probabilistic movement models such as uniform random walks or force dispersion.

We include in our library of objective step contribution computations a Levy Walk component that may be combined with other objectives that modulate the movement of the agent. We note that this additive combination of Levy Walk with other objectives is different from the movement model presented in [7], where the objective to react to obstacles may interrupt the Levy walk.

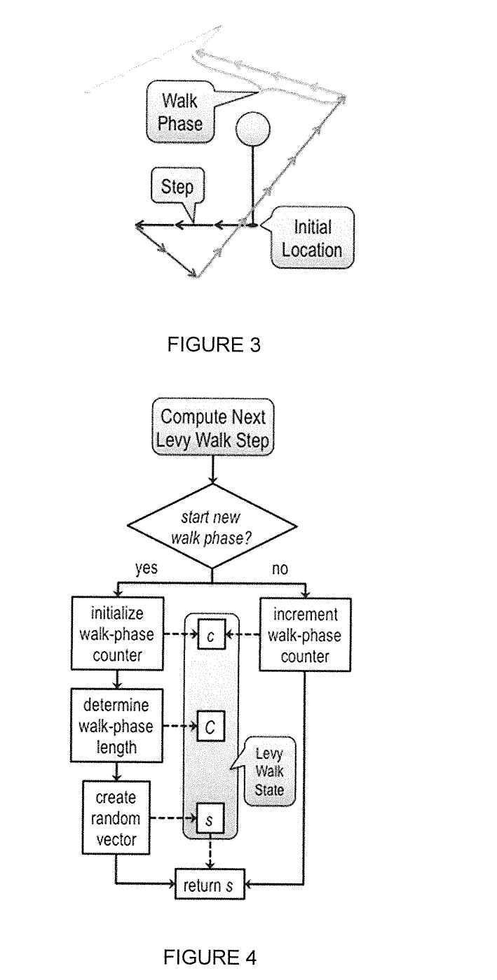

Our iterative Levy Walk model is characterized by “walk phases” of variable length, where each step calculation returns the same objective step contribution vector (FIG. 3). That vector is set at the beginning of the phase as described in the previous section (“Random Noise”). The duration of each phase, that is the number of times the same objective step contribution vector is returned, is also determined at the beginning of the phase as T/r, where T is a non-zero parameter of the Levy Walk model, and r is a randomly generated number in the (0,1] interval.

To realize the Levy Dispersion objective, each agent needs to maintain an internal Levy Walk State that is updated with each movement objective computation. The state is a tuple with three components {c, C, s}, where c is the number of steps already completed in this phase, C the target number of steps for the current phase, and s the “objective step contribution vector” in the agent's metric space used in the current walk phase.

To determine the next objective step contribution vector for an agent, we execute the following process (illustrated in FIG. 4):
If the agent starts a new walk phase (Levy Walk State not yet initialized, or c>C):
   Create a uniform random objective step contribution vector as described in the previous section (“Random Noise”), optionally scaled by a parameter w. Set the Levy Walk State component s to this vector so it can be used in each subsequent step.
   Sample a random number generator for a non-zero value q drawn uniformly from the range (0,1]. Compute the dispersion rate r as q raised to the power of F (r=q^{F}), where F is a tuning parameter (F>0) that controls the dispersion rate.
   Set the Levy Walk State components C to T/r and c to 0.
Otherwise:
   Increment the Levy Walk State component c by 1.
Use the current value of the Levy Walk State component s as this step's objective step contribution vector.

### Objective: Response to Objects

Many agent movement objectives can be expressed in the form “move towards or away from the current location of objects in a given set” where the objects are embedded in the same metric space as the agent. The direction of the movement (towards or away from) may be fixed or determined by the relationship (e.g., similarity) of the agent to the respective object in the set. The magnitude of the response may be further modulated by the current distance between the agent and the object.

Force dispersion (mentioned in the previous section “Levy Dispersion”) of multiple agents is an example of such an objective, where each agent moves away from other agents and the urgency to move away from another agent increases with decreasing distance to the other agent. Another example is the greedy (also increasing with decreasing distance) attraction (move towards) to a set of prioritized target locations with unmanned vehicles.

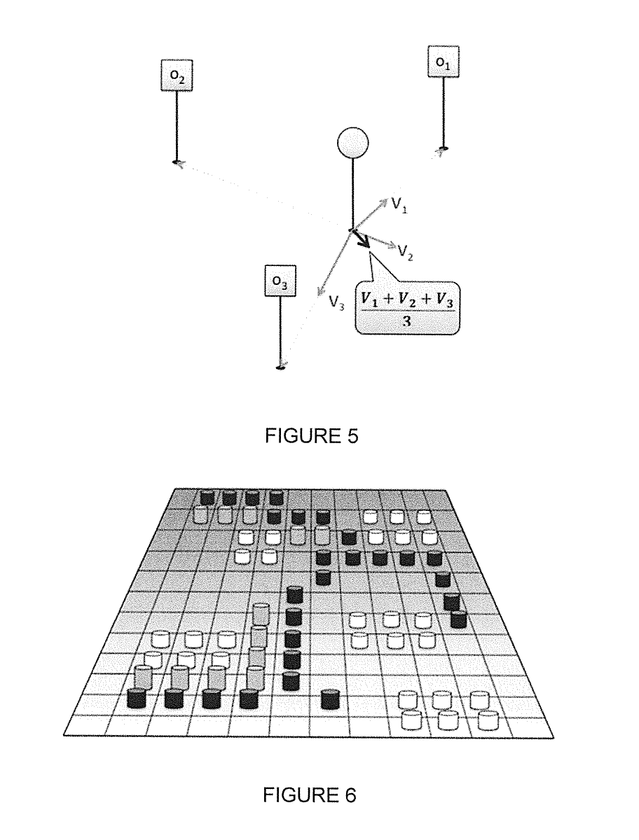

Our movement decision framework includes a heavily parameterized library function for the computation of objective step contribution vectors that meet this behavior template. The function takes as its input a set of objects O for which a single response movement relative to the current agent location should be computed. The computation proceeds in the following sequence of steps (FIG. 5):
For each object o in O, compute a response vector V
Compute the combined objective step contribution vector as the vector sum of the response vectors
Optionally, as determined by an application parameter, scale the length of the step vector by 1/|O|, normalizing the movement for the number of objects

The response vector for object o relative to the agent is computed as follows:
Compute the distance D between the agent and the object in the given space.
If D is zero, no response vector to object o will be computed in this step. Otherwise:
Initialize the response vector V as a vector pointing from the agent's location to the object's location (the length of V is D). All subsequent operations modulate the length of this vector but not its direction (other than potentially reversing it to negative length).
Compute a Distance Modulation factor DM (limited to [0,1]) as a function of D. DM may be constant (e.g., 1.0) or decreasing or increasing with D.
   The computation of DM is application-specific, but we often use one of following:
      Linear, e.g., DM=D/maxD or DM=1−D/maxD, where maxD is a normalization constant (equal to the maximum possible distance in a limited space)
      Exponential, e.g., DM=(Exp[D/maxD*s]−1)/(Exp[s]−1), where s is a shaping parameter
Compute any degree of repulsion R of the entity from the object. Compute any degree of attraction A of the agent to the object.
   Both R and A are computed application specific from the relationship of the agent with the object (e.g., A=similarity, R=dissimilarity)
Multiply V with DM*(R+A) and return the resulting response vector

### Objective: Field Gradient Climbing

There is a class of applications (e.g., swarming agent models) that guides agent movement through scalar fields superimposed on the metric space. For instance, the space may be divided into a regular grid of non-overlapping cells where each cell is assigned a single scalar value for each field as illustrated in FIG. 6.

Each such field may correspond to a unique objective for the agent, translating into a separate objective step contribution vector in our movement framework. For instance, the gradient of one field may guide the agent to desirable locations (e.g., targets) and thus higher field values are more attractive than lower ones. Conversely, gradient fields may be used to guide agents away from undesirable locations (e.g., threats).

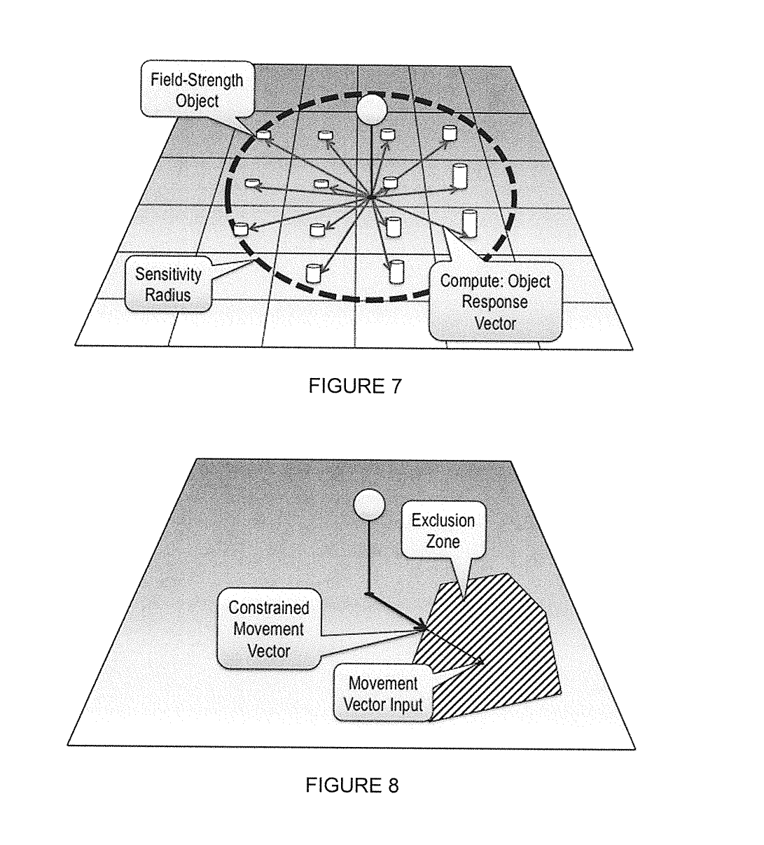

Our objective step contribution vector calculation treats the climbing (up or down) of the gradient of a specific field as a special class of object response movements (see previous section “Response to Objects”) by adding a specialized preparation step that assembles the objects to which the agent should respond. Specifically, for a given “sensitivity radius” (distance in metric space) of the agent, which is an application-specific parameter, we enumerate “field-strength” objects at given locations that carry the scalar value of the field at that location. In the case of the regular grid array, for instance, we consider all grid cells within the radius with their respective field value (FIG. 7). To these “field-strength” objects, we then compute the response vectors in the previously defined manner, where the relationship of the agent to the respective object is defined by the valence of the agent to the field values—repelling to climb down and attracting to climb up the gradient.

### Constraint: Limited Vector Length

The most straightforward constraint available is the explicit limitation of the length of the objective step contribution vector to a minimum and maximum value (parameters). If, for instance, the agent has a real-world counterpart (e.g., it controls the physical movement of a robotic vehicle), then these values, combined with the frequency at which movement decisions are repeated, correspond to the minimum and maximum speed at which the real-world entity can move. But also in non-physical models, such as in collective reasoning models, the speed of an agent may be constrained to allow other agents to respond smoothly to the changing location of the agent.

### Constraint: Exclusion Zones

The virtual or physical environment of the entity may be populated by obstacles. Rather than waiting for the actuation step of the movement model to “encounter” these obstacles and fail in the attainment of the next location, the application developer may already want to include knowledge of obstacles in the movement decision process as hard constraints.

The “exclusion zones” movement constraint in our library takes as (static or dynamic) parameterization the geometry of areas in the metric space that may not be target location of a legal move. A simple form of such a parameterization may take the form of a Boolean field (e.g., grid) superimposed on the overall area of interest, where specific field locations are either marked accessible or not. A more complex parameterization may provide exclusion zones as closed polygons where the inside of each shape is not accessible (FIG. 8).

The constraint takes as an input the current location and objective step vector for the agent. Using the exclusion zones, it returns the movement vector potentially shortened to the maximum possible step (up to the target location) that does not cross any exclusion zone.

### Movement Objective Contributions and Constraints in a Graph Topology

If the application agent is embedded in a graph topology with graph nodes as their possible locations and graph edges providing the means to change location, the movement objective step contributions, the preliminary movement step proposal, and the final movement step proposal all take the form of selection probabilities over outgoing edges of the node the agent is located at. The combination of objective step contributions logically combines probability distributions (component sum for “or”, component multiplication for “and”), and the application of constraints may reduce the probability for an edge to be selected. The execution of the movement step selects an edge to traverse with the probability associated with that edge after all objectives and constraints are applied.

### Objective: Random Noise

Creating artificial random noise in a graph-topology movement model is achieved by assigning a uniform probability to each available movement choice (edge).

### Objective: Response to Objects

As in the metric space embedding, objects may occupy node locations in the graph topology. Here we assume that the agent may only perceive and respond to objects located on direct neighbors (edge exists) of its current node. This objective's contribution is a set of selection probabilities for available edges proportional to the agent's (attractive or repulsive) relationship to the objects on the node following the edge from the current agent location.

### Objective: Field Gradient Climbing

As in the metric space embedding, scalar values may be associated with individual node locations, forming a field in the graph topology that may guide agent movement. These scalar values are transformed into probabilities over current movement options through normalization, inversion, or the application of “temperature”.

### Constraint: Exclusion Zones

An exclusion zone in a graph topology is a set of nodes that agents may not occupy. To apply this constraint, the agent sets the selection probability for any of these nodes to zero and re-normalizes the selection probability distribution.

### REFERENCES

[1] F. Mondada, G. C. Pettinaro, A. Guignard, I. W. Kwee, D. Floreano, J.-L. Deneubourg, S. Nolfi, L. M. Gambardella, and M. Dorigo, “SWARM-BOT: A new distributed robotic concept,” Autonomous Robots, vol. 17, no. 2-3, pp. 193-221, 2004.
[2] H. V. D. Parunak, S. Brueckner, and J. Sauter, “Digital pheromone mechanisms for coordination of unmanned vehicles,” in Proceedings of the first international joint conference on Autonomous agents and multiagent systems: part 1, 2002, pp. 449-450.
[3] D. K. Rossmo, Geographic profiling. CRC press, 1999.
[4] J. M. Epstein, “Agent-based computational models and generative social science,” Generative Social Science: Studies in Agent-Based Computational Modeling, vol. 4, no. 5, pp. 4-46, 1999.
[5] E. Ogston, B. Overeinder, M. Van Steen, and F. Brazier, “A method for decentralized clustering in large multi-agent systems,” in Proceedings of the second international joint conference on Autonomous agents and multiagent systems, 2003, pp. 789-796.
[6] M. L. Huang and P. Eades, “A fully animated interactive system for clustering and navigating huge graphs,” in Graph Drawing, 1998, pp. 374-383.
[7] S. Brueckner, T. C. Belding, R. Bisson, E. Downs, and H. V. D. Parunak, “Swarming Polyagents Executing Hierarchical Task Networks,” in Self-Adaptive and Self-Organizing Systems, 2009. SASO '09. Third IEEE International Conference on, 2009, pp. 51-60.

1. A method of combining objectives and constraints specific to a particular application into a sequence of location changes of autonomous software agents in a distributed and decentralized computational or physical environment, the agents being operative to perform independent processes including a Movement process, the method comprising the steps of:
receiving available situational data associated with the application;
proposing an agent location change derived from an arbitrary number of objectives and constraints based on the available situational data;
attempting, for a limited time defined by the application, to attain a new location implied by the proposed location change; and
continuously and repeatedly executing the processes by the agents to create agent movement trajectories to meet the objectives of the application.

2. The method of claim 1, wherein the available situational data includes one or more of the following:
sensor information,
the presence or absence of object representations of certain characteristics in the agent's environment, and
knowledge of the movement capabilities of a real-world entity controlled by the agent.

3. The method of claim 1, wherein the proposed location change is computed in a decision process, comprising the steps of:
producing, independently for each application-specific objective, a movement objective step contribution that implies where the given objective would move the agent;
combining all movement objective step contributions into a preliminary movement step proposal; and
applying all application-specific constraints in an application-defined sequence to the preliminary movement step, thereby arriving at a final movement step proposal for attainment by the agent.

4. The method of claim 1, wherein the distributed and decentralized computational or physical environment includes a metric space.

5. The method of claim 3, wherein the movement objective step contributions, preliminary, and final movement step proposals are vectors with a heading and magnitude in an embedding metric space.

6. The method of claim 5, where the combination of movement objective step contributions is a vector addition operation, and where the application-specific constraints change the magnitude but not the heading of the proposed movement step.

7. The method of claim 5, including an objective to include random noise in the movement decision process by producing a new vector of unit length and uniformly random direction in each movement step.

8. The method of claim 5, including an objective to include Levy Dispersion in the movement decision process by producing a new vector of unit length and uniformly random direction in each Levi walk phase that spans T/r movement steps, where T is a non-zero parameter of the Levy Walk model, and r is a randomly generated number in the (0,1] interval.

9. The method of claim 5, including an objective to include responses to a given set of arbitrary objects and their locations in the metric space in the movement decision process by combining individual response vectors from the agent to each object location modulated by the agent's relation to the object, where the combination function is the sum of all response vectors divided by the number of the response vectors.

10. The method of claim 9, wherein the objects are scalar field-strength values associated with specific locations in the agents' vicinity and the combination of response vectors to these field values results in a ascent or descent of the agent on the gradient of that field.

11. The method of claim 3, wherein a constraint on the movement of the agent is an application-specific minimum or maximum speed that is enforced on the length of the preliminary movement step proposal vector.

12. The method of claim 3, wherein a constraint on the movement of the agent is the avoidance of application-specific exclusion zones that is enforced by reducing the length of the preliminary movement step proposal vector such that the proposed step does not take the agent into or over an exclusion zone.

13. The method of claim 1, wherein the distributed and decentralized computational or physical environment includes a graph with its nodes being available agent locations and its edges enumerate the available movement choices of each agent.

14. The method of claim 13, wherein the movement objective step contributions, preliminary, and final movement step proposals are probability distributions over the set of outgoing edges from the node of the current agent location in the graph topology, and wherein the probability associated with a single such edge corresponds to the likelihood that the agent will choose to traverse that edge to the node on its opposite end.

15. The method of claim 13, wherein the combination of movement objective step contributions is an operation combining multiple probability distributions into one, and wherein the application-specific constraints change individual probabilities in the proposed movement step.

16. The method of claim 13, wherein an objective to include random noise in the movement decision process is realized by producing a uniform probability distribution over the outgoing edges in each movement step.

17. The method of claim 13, including an objective to include responses to a given set of arbitrary objects located at the nodes opposite of the outgoing edges of the agent's current node in the movement decision process by combining individual response values derived from the agent's relation to each object, and wherein the combination function is the sum of all response values for each unique outgoing edge divided by the total sum of response values to form a probability distribution over outgoing edges.

18. The method of claim 17, wherein the objects are scalar field-strength values associated with nodes opposite of the outgoing edges of the agent's current node and the combination of agent response values to these field values results in a ascent or descent of the agent on the gradient of that field across the graph topology.

19. The method of claim 13, wherein a constraint on the movement of the agent is the avoidance of application-specific exclusion zones that is enforced by setting to zero the probability associated with any outgoing edge from the agent's current node to an excluded node, thereby preventing the agent from stepping onto an excluded node.
